(19) United States
(12) Patent Application Publication
(10) Pub. No.: US 2002/0050456 A1
(43) Pub. Date: May 2, 2002

(54) Use of vapor-deposited conformal coatings in microfluidic structures

(76) Inventors: Norman F. Sheppard JR., Bedford, MA (US); Bruce L. Carvalho, Watertown, MA (US)

Correspondence Address: MCDONNELL BOEHNEN HULBERT & BERGHOFF, 300 SOUTH WACKER DRIVE, SUITE 3200, CHICAGO, IL, 60606, US

(21) Appl. No.: 09/858,313

(22) Filed: May 15, 2001

Related U.S. Application Data
(60) Provisional application No. 60/204,299, filed on May 15, 2000.

(51) Int. Cl. G01N 27/26; G01N 27/447

(52) U.S. Cl. 204/451; 204/601

(57) ABSTRACT

This invention relates to methods and apparatus for performing microanalytic and microsynthetic analyses and procedures. The invention particularly provides microsystem platforms comprising microfluidics components wherein the interior surfaces of the components comprise a conformal coating of parylene.

This application claims priority to U.S. Provisional Applications Ser. No. 60/204,299, filed May 15, 2000, the disclosure of which is explicitly incorporated by reference herein.

### FIELD OF THE INVENTION

This invention relates to chemical and biological assay technology carried out in disposable plastic assemblies, and in particular the devices referred to as microfluidic systems as disclosed in U.S. Pat. No. 6,063,589, issued May 16, 2000, and co-owned and co-pending patent applications U.S. Ser. Nos. 08/761,063, filed Dec. 5, 1996; 08/768,990, filed Dec. 18, 1996; 08/910,726, filed Aug. 12, 1997; 08/995,056, filed Dec. 19, 1997; and 09/315,114, filed May 19, 1999, the disclosures of each of which are explicitly incorporated by reference herein.

### BACKGROUND OF THE RELATED ART

One of the key requirements of a general purpose microfluidic device is that it is stable with respect to a variety of fluid types. In applications that involve organic solvents or acid or basic aqueous solutions, it is important that the fluid does not dissolve nor swell the interior surfaces of the device thereby altering the nature of the assay fluid and the performance of the device. Dissolution or swelling are real possibilities if the device is made from plastic, as is the present trend.

A less obvious, but equally important loss of stability occurs when molecules from the assay fluid bind to the device itself. For example, in microfluidic serum binding assays of pharmaceutical compounds, the assay yields a true binding curve only when neither a significant amount of serum nor pharmaceutical compound binds, non specifically, to the interior surface of the device.

A number of coating processes have been developed that may either protect or passivate a surface but these processes rarely produce conformal coatings. A protecting layer of silicon, for example, may be thermally evaporated and deposited onto an open, plastic microfluidic device but since this type of deposition is line-of-sight it can be difficult to provide uniform coating of deep and tall features. Liquid coatings of epoxies or urethanes onto a microfluidic device may leave menisci around sharp edges and fill or bridge depressions and channels, thereby altering the physical configuration of the device.

Parylene is the trade name for the family of vapor-deposited para-xylene polymers that find use as barrier and surface modification coatings of electronic and biomedical devices. The major steps of the deposition process include vaporization, at 175° C., and subsequent pyrolysis, at 680° C., of di-para-xylene to produce a vapor of para-xylene monomer that deposits and polymerizes, at 25° C., onto all exposed surfaces.

Standard reactors have a staged pressure gradient that drives the molecules from the vaporization chamber to the pyrolysis chamber and, finally, to the deposition chamber. Deposition and polymerization occur at approximately 0.1 torr and at this pressure the mean free path of the para-xylene monomer is approximately 1 mm. Such a short mean free path ensures that the vapor phase molecules collide thousands of times before deposition and that the deposition is therefore conformal. Typical layer thicknesses can range from one-tenth to tens of microns and this depends on the exposure duration, which can be controlled with precision. Parylene coatings display a good resistance to a wide variety of solvents including water, alcohols, aliphatic hydrocarbons, fluorocarbons, amines, ketones, and strong acids and bases. Additional information about the properties of parylene, deposition process and applications can be found in: Handbook of Plastics and Elastomers, C. A. Harper, ed., p. 1-82ff, McGraw-Hill, NY, 1975.

U.S. Pat. No. 6,138,349 discloses the use of parylene as a protective coating of an electronic device. In this application, a parylene coating insulates electrical leads from the surrounding, potentially aqueous or humid, environment, thereby preventing short circuits. Humphrey, “Using Parylene for Medical Substrate Coating”, Medical Plastics and Biomaterials, Jan. 1996 reports the use of parylene as a lubricious coating of bone pins and other prothestic hardware, as an insulating coating for lead wires within catheters and as a hydrophobic coating of the exterior and interior surfaces of needles.

Parylene is also used to build structures within microscale devices. Webster et al., 1998, “An Inexpensive Plastic Technology for Microfabricated Capillary Electrophoresis Chips,” in MICRO TOTAL ANALYSIS SYSTEMS ′98, Harrison and van den Berg, eds. (Kluwer: The Netherlands), pp. 249-252, disclose the use of the parylene deposition process to form defining walls of microfluidic channels. In this approach, parylene is deposited onto a polycarbonate substrate, a sacrificial photoresist layer is then deposited onto the parylene coating and then parylene is deposited onto three sides of the sacrificial photoresist layer. When the composite system is soaked in acetone for approximately 36 hours, the photoresist is released or dissolves and one is left with a four-sided parylene channel.

There remains a need in the art to develop improved microfluidics devices that are resistant to and have minimum adsorbsion of chemical compounds such-as acids, bases and other harsh chemicals, or rare or expensive compounds such as natural products or drug lead compounds. There is also a need to such improved microfluidics devices that show minimal adsorbsion of biological samples or the components thereof. Relevant to this need in the art, some of the present inventors have developed a microsystem platform and a micromanipulation device to manipulate said platform by rotation, thereby utilizing the centripetal forces resulting from rotation of the platform to motivate fluid movement through microchannels embedded in the microplatform, as disclosed in co-owned U.S. Pat. No. 6,063,589, issued May 16, 2000, and co-owned and co-pending patent applications U.S. Ser. Nos. 08/761,063, filed Dec. 5, 1996; 08/768,990, filed Dec. 18, 1996; 08/910,726, filed Aug. 12, 1997; 08/995,056, filed Dec. 19, 1997; and 09/315,114, filed May 19, 1999, the disclosures of each of which are explicitly incorporated by reference herein. cl SUMMARY OF THE INVENTION

Microfluidic systems are closed interconnected networks/systems of channels and reservoirs with characteristic dimensions ranging from microns to millimeters. By introducing fluids, reagents and samples into the devices, chemical and biological assays can be carried out in an integrated and automated way.

The simplest microfluidic systems are constructed by bonding a cover to a substrate in which the channels have been formed. An adhesive or adhesive tape may be required to join the substrate and cover, as adhesiveless bonding methods such as ultrasonic welding become increasingly difficult as the dimensions of the channels decrease. Unfortunately, there is a potential for contamination of the fluids by the adhesive material (or the plastic substrate or cover). Interfering substances leaching from the adhesive, or adsorption and binding of substances by the adhesive, can interfere with chemical or biochemical reactions. This can be more of a problem at elevated temperatures or if solvents, strong acids or bases are required.

This invention describes the use of a vapor-deposited conformal coating to form a barrier layer or surface modification layer on the internal, fluid-contacting surfaces of a microfluidic device following construction. As a barrier layer, the coating forms an impermeable layer that prevents an exchange of matter between the fluids and materials used to construct the device. The use of a low temperature, vapor deposition method allows the device to be manufactured and then passivated in its final form. The idea can be used to improve the performance of assays, or to permit the use of solvents or reagents that are incompatible with the materials used to construct the disc.

Certain preferred embodiments of the apparatus of the invention are described in greater detail in the following sections of this application and in the Examples and claims.

### DETAILED DESCRIPTION OF PREFERRED EMBODIMENTS

This invention provides a microplatform and a micromanipulation device as disclosed in co-owned U.S. Pat. No. 6,063,589, issued May 16, 2000, and co-owned and co-pending patent applications U.S. Ser. Nos. 08/761,063, filed Dec. 5, 1996; 08/768,990, filed Dec. 18, 1996; 08/910,726, filed Aug. 12, 1997; 08/995,056, filed Dec. 19, 1997; 09/315,114, filed May 19, 1999, the disclosures of each of which are explicitly incorporated by reference herein, wherein the internal surfaces of the microfluidics structures on the platform comprise a vapor-deposited conformal coating to form a barrier layer or surface modification layer thereupon.

For the purposes of this invention, the term “sample” will be understood to encompass any fluid, solution or mixture, either isolated or detected as a constituent of a more complex mixture, or synthesized from precursor species.

For the purposes of this invention, the term “a centripetally motivated fluid micromanipulation apparatus” is intended to include analytical centrifuges and rotors, microscale centrifugal separation apparatuses, and most particularly the microsystems platforms and disk handling apparatuses as described in co-owned U.S. Pat. No. 6,063,589, issued May 16, 2000, and co-owned and co-pending patent applications U.S. Ser. Nos. 08/761,063, filed Dec. 5, 1996; 08/768,990, filed Dec. 18, 1996; 08/910,726, filed Aug. 12, 1997; 08/995,056, filed Dec. 19, 1997; 09/315,114, filed May 19, 1999, the disclosures of each of which are explicitly incorporated by reference herein.

For the purposes of this invention, the term “Microsystems platform” is intended to include centripetally-motivated microfluidics arrays as described in co-owned U.S. Pat. No. 6,063,589, issued May 16, 2000, and co-owned and co-pending patent applications U.S. Ser. Nos. 08/761,063, filed Dec. 5, 1996; 08/768,990, filed Dec. 18, 1996; 08/910,726, filed Aug. 12, 1997; 08/995,056, filed Dec. 19, 1997; 09/315,114, filed May 19, 1999, the disclosures of each of which are explicitly incorporated by reference herein.

For the purposes of this invention, the terms “capillary”, “microcapillary” and “microchannel” will be understood to be interchangeable and to be constructed of either wetting or non-wetting materials where appropriate.

For the purposes of this invention, the term “capillary junction” will be understood to mean a region in a capillary or other flow path where surface or capillary forces are exploited to retard or promote fluid flow. A capillary junction is provided as a pocket, depression or chamber in a hydrophilic substrate that has a greater depth (vertically within the platform layer) and/ or a greater width (horizontally within the platform layer) that the fluidics component (such as a microchannel) to which it is fluidly connected. For liquids having a contact angle less than 90° (such as aqueous solutions on platforms made with most plastics, glass and silica), flow is impeded as the channel cross-section increases at the interface of the capillary junction. The force hindering flow is produced by capillary pressure, that is inversely proportional to the cross sectional dimensions of the channel and directly proportional to the surface tension of the liquid, multiplied by the cosine of the contact angle of the fluid in contact with the material comprising the channel. The factors relating to capillarity in microchannels according to this invention have been discussed in co-owned U.S. Pat. No. 6,063,589, issued May 12, 2000 and in co-owned and co-pending U.S. patent application, Ser. No. 08/910,726, filed Aug. 12, 1997, incorporated by reference in its entirety herein.

Capillary junctions can be constructed in at least three ways. In one embodiment, a capillary junction is formed at the junction of two components wherein one or both of the lateral dimensions of one component is larger than the lateral dimension(s) of the other component. As an example, in microfluidics components made from “wetting” or “wettable” materials, such a junction occurs at an enlargement of a capillary as described in co-owned and co-pending U.S. Ser. Nos. U.S. Ser. Nos. 08/761,063, filed Dec. 5, 1996; 08/768,990, filed Dec. 18, 1996; and 08/910,726, filed Aug. 12, 1997. Fluid flow through capillaries is inhibited at such junctions. At junctions of components made from non-wetting or non-wettable materials, on the other hand, a constriction in the fluid path, such as the exit from a chamber or reservoir into a capillary, produces a capillary junction that inhibits flow. In general, it will be understood that capillary junctions are formed when the dimensions of the components change from a small diameter (such as a capillary) to a larger diameter (such as a chamber) in wetting systems, in contrast to non-wettable systems, where capillary junctions form when the dimensions of the components change from a larger diameter (such as a chamber) to a small diameter (such as a capillary).

A second embodiment of a capillary junction is formed using a component having differential surface treatment of a capillary or flow-path. For example, a channel that is hydrophilic (that is, wettable) may be treated to have discrete regions of hydrophobicity (that is, non-wettable). A fluid flowing through such a channel will do so through the hydrophilic areas, while flow will be impeded as the fluid-vapor meniscus impinges upon the hydrophobic zone.

The third embodiment of a capillary junction according to the invention is provided for components having changes in both lateral dimension and surface properties. An example of such a junction is a microchannel opening into a hydrophobic component (microchannel or reservoir) having a larger lateral dimension. Those of ordinary skill will appreciate how capillary junctions according to the invention can be created at the juncture of components having different sizes in their lateral dimensions, different hydrophilic properties, or both.

For the purposes of this invention, the term “capillary action” will be understood to mean fluid flow in the absence of rotational motion or centripetal force applied to a fluid on a rotor or platform of the invention and is due to a partially or completely wettable surface.

For the purposes of this invention, the term “capillary microvalve” will be understood to mean a capillary microchannel comprising a capillary junction whereby fluid flow is impeded and can be motivated by the application of pressure on a fluid, typically by centripetal force created by rotation of the rotor or platform of the invention. Capillary microvalves will be understood to comprise capillary junctions that can be overcome by increasing the hydrodynamic pressure on the fluid at the junction, most preferably by increasing the rotational speed of the platform.

For the purposes of this invention, the term “in fluid communication” or “fluidly connected” is intended to define components that are operably interconnected to allow fluid flow between components.

The microplatforms of the invention (preferably and hereinafter collectively referred to as “disks”; for the purposes of this invention, the terms “microplatform”, “Microsystems platform” and “disk” are considered to be interchangeable) are provided to comprise one or a multiplicity of microsynthetic or microanalytic systems (termed “microfluidics structures” herein). Such microfluidics structures in turn comprise combinations of related components as described in further detail herein that are operably interconnected to allow fluid flow between components upon rotation of the disk. These components can be microfabricated as described below either integral to the disk or as modules attached to, placed upon, in contact with or embedded in the disk. For the purposes of this invention, the term “microfabricated” refers to processes that allow production of these structures on the sub-millimeter scale. These processes include but are not restricted to molding, photolithography, etching, stamping and other means that are familiar to those skilled in the art.

The invention also comprises a micromanipulation device for manipulating the disks of the invention, wherein the disk is rotated within the device to provide centripetal force to effect fluid flow on the disk. Accordingly, the device provides means for rotating the disk at a controlled rotational velocity, for stopping and starting disk rotation, and advantageously for changing the direction of rotation of the disk. Both electromechanical means and control means, as further described herein, are provided as components of the devices of the invention. User interface means (such as a keypad and a display) are also provided, as further described in co-owned U.S. Pat. No. 6,063,589, issued May 16, 2000, and co-owned and co-pending patent applications U.S. Ser. Nos. 08/761,063, filed Dec. 5, 1996; 08/768,990, filed Dec. 18, 1996; 08/910,726, filed Aug. 12, 1997; 08/995,056, filed Dec. 19, 1997; 09/315,114, filed May 19, 1999, the disclosures of each of which are explicitly incorporated by reference herein.

The invention provides a combination of specifically-adapted microplatforms that are rotatable, analytic/synthetic microvolume assay platforms, and a micromanipulation device for manipulating the platform to achieve fluid movement on the platform arising from centripetal force on the platform as result of rotation. The platform of the invention is preferably and advantageously a circular disk; however, any platform capable of being rotated to impart centripetal for a fluid on the platform is intended to fall within the scope of the invention. The micromanipulation devices of the invention are more fully described in co-owned and co-pending U.S. Ser. Nos. U.S. Ser. Nos. 08/761,063, filed Dec. 5, 1996; 08/768,990, filed Dec. 18, 1996; 08/910,726, filed Aug. 12, 1997; 08/995,056, filed Dec. 19, 1997; and 09/315,114, filed May 19, 1999, the disclosures of each of which are explicitly incorporated by reference herein.

Fluid (including reagents, samples and other liquid components) movement is controlled by centripetal acceleration due to rotation of the platform. The magnitude of centripetal acceleration required for fluid to flow at a rate and under a pressure appropriate for a particular microfluidics structure on the microsystems platform is determined by factors including but not limited to the effective radius of the platform, the interior diameter of microchannels, the position angle of the microchannels on the platform with respect to the direction of rotation, and the speed of rotation of the platform. In certain embodiments of the methods of the invention an unmetered amount of a fluid (either a sample or reagent solution) is applied to the platform and a metered amount is transferred from a fluid reservoir to a microchannel, as described in co-owned U.S. Patent No. 6,063,589, issued May 16, 2000, and co-owned and co-pending patent applications U.S. Ser. Nos. 08/761,063, filed Dec. 5, 1996; 08/768,990, filed Dec. 18, 1996; 08/910,726, filed Aug. 12, 1997; 08/995,056, filed Dec. 19, 1997; 09/315,114, filed May 19, 1999, the disclosures of each of which are explicitly incorporated by reference herein. In preferred embodiments, the metered amount of the fluid sample provided on an inventive platform is from about 1 nL to about 500 μL. In these embodiments, metering manifolds comprising one or a multiplicity of metering capillaries are provided to distribute the fluid to a plurality of components of the microfluidics structure.

The components of the platforms of the invention are in fluidic contract with one another. In preferred embodiments, fluidic contact is provided by microchannels comprising the surface of the platforms of the invention. Microchannel sizes are optimally determined by specific applications and by the amount of and delivery rates of fluids required for each particular embodiment of the platforms and methods of the invention. Microchannel sizes can range from 0.1 μm to a value close to the thickness of the disk (e.g., about 1 mm); in preferred embodiments, the interior dimension of the microchannel is from 0.5 μm to about 500 μm. Microchannel and reservoir shapes can be trapezoid, circular or other geometric shapes as required. Microchannels preferably are embedded in a microsystem platform having a thickness of about 0.1 to 25 mm, wherein the cross-sectional dimension of the microchannels across the thickness dimension of the platform is less than 1 mm, and can be from 1 to 90 percent of said cross-sectional dimension of the platform. Sample reservoirs, reagent reservoirs, reaction chambers, collection chambers, detections chambers and sample inlet and outlet ports preferably are embedded in a microsystem platform having a thickness of about 0.1 to 25 mm, wherein the cross-sectional dimension of the microchannels across the thickness dimension of the platform is from 1 to 75 percent of said cross-sectional dimension of the platform. In preferred embodiments, delivery of fluids through such channels is achieved by the coincident rotation of the platform for a time and at a rotational velocity sufficient to motivate fluid movement between the desired components.

The flow rate through a microchannel of the invention is inversely proportional to the length of the longitudinal extent or path of the microchannel and the viscosity of the fluid and directly proportional to the product of the square of the hydraulic diameter of the microchannel, the square of the rotational speed of the platform, the average distance of the fluid in the channels from the center of the disk and the radial extent of the fluid subject to the centripetal force. Since the hydraulic diameter of a channel is proportional to the ratio of the cross-sectional area to cross-sectional perimeter of a channel, one can judiciously vary the depth and width of a channel to affect fluid flow (see Duffy et al., 1998, Anal. Chem. 71: 4669-4678 and co-owned and co-pending patent applications U.S. Ser. Nos. 08/761,063, filed Dec. 5, 1996 and 08/768,990, filed Dec. 18, 1996, incorporated by reference).

For example, fluids of higher densities flow more rapidly than those of lower densities given the same geometric and rotational parameters. Similarly, fluids of lower viscosity flow more rapidly than fluids of higher viscosity given the same geometric and rotational parameters. If a microfluidics structure is displaced along the radial direction, thereby changing the average distance of the fluid from the center of the disc but maintaining all other parameters, the flow rate is affected: greater distances from the center result in greater flow rates. An increase or a decrease in the radial extent of the fluid also leads to an increase or decrease in the flow rate. These dependencies are all linear. Variation in the hydraulic diameter results in a quartic dependence of flow rate on hydraulic diameter (or quadratic dependence of fluid flow velocity on hydraulic diameter), with larger flow rates corresponding to larger diameters. Finally, an increase in the rotational rate results in a quadratic increase in the flow rate or fluid flow velocity.

Platforms of the invention such as disks and the microfluidics components comprising such platforms are advantageously provided having a variety of composition and surface coatings appropriate for particular applications. Platform composition will be a function of structural requirements, manufacturing processes, and reagent compatibility/chemical resistance properties. Specifically, platforms are provided that are made from inorganic crystalline or amorphous materials, e.g. silicon, silica, quartz, inert metals, or from organic materials such as plastics, for example, poly(methyl methacrylate) (PMMA), acetonitrile-butadiene-styrene (ABS), polycarbonate, polyethylene, polystyrene, polyolefins, polypropylene and metallocene. These may be used with unmodified or modified surfaces as described below. The platforms may also be made from thermoset materials such as polyurethane and poly(dimethyl siloxane) (PDMS). Also provided by the invention are platforms made of composites or combinations of these materials; for example, platforms manufactures of a plastic material having embedded therein an optically transparent glass surface comprising the detection chamber of the platform. Alternately, platforms composed of layers made from different materials may be made. The surface properties of these materials may be modified for specific applications, as disclosed in co-owned U.S. Pat. No. 6,063,589, issued May 16, 2000, and co-owned and co-pending patent applications U.S. Ser. Nos. 08/761,063, filed Dec. 5, 1996; 08/768,990, filed Dec. 18, 1996; 08/910,726, filed Aug. 12, 1997; 08/995,056, filed Dec. 19, 1997; and 09/315,114, filed May 19, 1999, the disclosures of each of which are explicitly incorporated by reference herein.

Preferably, the disk incorporates microfabricated mechanical, optical, and fluidic control components on platforms made from, for example, plastic, silica, quartz, metal or ceramic. These structures are constructed on a sub-millimeter scale by molding, photolithography, etching, stamping or other appropriate means, as described in more detail below. It will also be recognized that platforms comprising a multiplicity of the microfluidic structures are also encompassed by the invention, wherein individual combinations of microfluidics and reservoirs, or such reservoirs shared in common, are provided fluidly connected thereto.

The simplest microfluidic systems are constructed by bonding a cover to a substrate in which fluid flow channels, particularly microchannels have been formed. An adhesive or adhesive tape may be required to join the substrate and cover, as adhesiveless bonding methods such as ultrasonic welding become increasingly difficult as the dimensions of the channels decrease. Unfortunately, there is a potential for contamination of the fluids by the adhesive material (or the plastic substrate or cover). Interfering substances leaching from the adhesive, or adsorption and binding of substances by the adhesive, can interfere with chemical or biochemical reactions. This can be more of a problem at elevated temperatures or if solvents, strong acids or bases are required.

### PLATFORM MANUFACTURE AND ASSEMBLY

Parylene as a barrier layer within a microfluidic device:

A problem in the art is poor (or reduced) yields of polymerase chain reaction (PCR)product in amplifications run on plastic centrifugal microfluidics disc as described in U.S. Pat. No. 6,063,589, issued May 16, 2000, and co-owned and co-pending patent applications U.S. Ser. Nos. 08/761,063, filed Dec. 5, 1996; 08/768,990, filed Dec. 18, 1996; 08/910,726, filed Aug. 12, 1997; 08/995,056, filed Dec. 19, 1997; and 09/315,114, filed May 19, 1999, the disclosures of each of which are explicitly incorporated by reference herein. One possible source of the problem is adhesive tape used in the construction of the disc that could interfere with the PCR reaction in some way. This hypothesis is supported by the observation that ethidium bromide, a cationic, DNA-binding dye, preferentially bound to the exposed adhesive tape in discs. Adhesive tape can comprise adhesive formulations containing polymers formed from acrylic or methacrylic acid. At neutral pH, these groups could serve as ion exchange sites, exchanging their protons for cations in the solution such as ethidium bromide. During PCR, this ion exchange could reduce the magnesium concentration in solution, and at the same time lower the pH.

In a simple experiment, a sample of adhesive tape was placed in a beaker and deionized water added. After 5 minutes, the pH was 2 units lower than a control having no adhesive tape. Subsequent experiments examined the magnesium concentrations in samples before and after contact with the disc, and it was observed that magnesium concentrations were reduced in samples that had been placed in the disc. These results demonstrated a need to manufacture the discs in a way in which minimized contact between the tape and the sample.

The invention provides a solution to this adhesive-associated problem: coating the internal fluidic manifold with parylene provides an impermeable barrier between the fluid and tape. It is known in the art that vapor deposited parylene forms a conformal coatings on open devices. This invention discloses the use of the parylene vapor deposition process to coat pre-assembled microfluidic devices.

For the preassembled devices discussed here, para-xylene vapor is introduced into each microfluidic manifold through several sample and reagent entry ports and air vents. In typical microfluidic devices, ports are sized to accommodate standard pipette tips and have cross-sectional dimensions between 1 mm and 5 mm; air vents have diameters close to 1 mm; channels that allow fluid transport, metering, mixing and other processing steps within the microfluidic device have cross-sectional dimensions between 51 m and 1 mm and lengths between 1 mm and hundreds of millimeters; typical dimensions of reagent reservoirs, detection cuvettes and other chambers have depths and diameters between 1 mm and 10 mm. Additional means for the diffusion of monomer into a microfluidic device can be provided by the inclusion of additional vents, often without compromising the function and performance of the device. It is known in the art that poly(para-xylxylene) forms when the monomeric vapor polymerizes on an exposed surface. When the devices are optically clear it is possible to view the interior surfaces of the microfluidic devices. The application of a coating between 100 nm and several microns may be detected through the visual appearance of interference colors from the interior surface.

he invention is additionally taught through the non-limiting example below.

### Example 1

Microfluidic devices were fabricated from cast acrylic sheet (PMMA, ICI Acrylics, St. Louis, Mo.) using a computer controlled milling machine (Benchman VMC-4000, Light Machines Corp., Manchester, N.H.) and a selection of end-mills that ranged in diameter from 250 μm to 1.6 mm. The machined acrylic surfaces were polished with methylene chloride vapor and then sealed with a layer of doubled-sided tape (7953MP, 3M, Minneapolis, Minn.) and subsequently backed with a clear polyester sheet. The fabricated devices had the shape of a disc and were used to perform centrifugal microfluidic assays.

After assembly, the discs were coated with parylene. Parylene was allowed to diffuse into the microfluidic manifold through nine ports: three sample and reagent ports near the inner diameter of the disc, and two reagent ports near the outer diameter of the disc, each contained a 2 mm opening to the ambient environment; the reaction cuvette was connected to a 500 μm wide by 250 μm deep by 1 cm long channel that was terminated in a 1 mm diameter vent to the ambient environment. The remaining vapor entry means consisted of 1 mm diameter air vents that were connected to the manifold with 250 ∞m wide by 250 mm deep by 5 mm long air vents. Test coupons placed in the reactor showed that approximately 25 μm of parylene was deposited onto the external surfaces of the discs. Visualization of interference colors within and throughout the microfluidic manifold show that parylene does, in fact, coat the internal surfaces of the microfluidic device. The hues of the interference colors suggest that the internal surfaces of the microfluidic manifold received coatings between 1 and several microns thick.

The parylene coated discs were functionally tested by running PCR reactions within the discs. These functional tests consist of loading sample, lysis buffer and the appropriate liquid reagents to the disc and then subjecting the disc to a standard thermal cycling profile. These experiments showed successful amplification of the expected PCR product. Quantitation of the amount of PCR product using fluorescence microscopy indicated that the yield of product was better than 90% that of the control run in a thermal cycler. Previous experiments where parylene was not used resulted in product yields ranging up to at most 50%.

It should be understood that the foregoing disclosure emphasizes certain specific embodiments of the invention and that all modifications or alternatives equivalent thereto are within the spirit and scope of the invention.

What is claimed is:

1. A microfluidic platform comprising a plurality of microfluidics components fluidly connected by microchannels, wherein each of the microfluidic components and microchannels comprises an interior surface, where the combination of microfluidic components defines a manifold, where the manifold communicates to the ambient atmosphere through ports and vents and where each interior surface is coated with a conformal coating of parylene.

2. A method for producing a preassembled device of claim 1 through the use of vapor deposition of parylene.

3. The device of claim 1, where the parylene coating serves as an impermeable barrier between the fluid and the microfluidic manifold material, thereby, enhancing the performance of a biochemical assays.

4. The device of claim 1, where adhesive tape is used for the purposed of sealing and assembly.

5. The device of claim 1, where the parylene coating serves as an impermeable barrier between the fluid and the microfluidic manifold material, thereby, enhancing the performance of a PCR amplification assay.
